(19) United States
(12) Patent Application Publication
(10) Pub. No.: US 2026/0185376 A1
(43) Pub. Date: Jul. 2, 2026

(54) A CLAMP FOR COUPLING TEMPORARY FENCING PANELS

(71) Applicant: Jonathan PLANT, Uffington (GB)

(72) Inventor: Jonathan PLANT, Uffington (GB)

(21) Appl. No.: 19/124,314

(22) PCT Filed: Nov. 6, 2023
(86) PCT No.: PCT/GB2023/052892

§ 371 Date: Apr. 25, 2025

(30) Foreign Application Priority Data
Nov. 4, 2022 (GB) 2216494.1

(51) Int. Cl. E04H 17/16; E04H 17/18; F16B 2/10; F16B 7/04

(52) U.S. Cl. CPC E04H 17/163; E04H 17/185; F16B 2/10; F16B 7/0433

(57) ABSTRACT

A clamp for coupling together temporary fencing panels. The clamp comprises two pairs of clamping jaws, arranged side by side with jaw mouths facing the same direction. The inner jaw of each pair is hinged to the frame to allow each pair to close around an upright of the fencing panel. Between the inner jaws is a bias spring that biases the hinged jaws towards the closed position. The clamp also comprises a locking mechanism that can selectively inhibit movement of the inner jaws to hold the pairs of jaws closed in order to prevent unauthorised removal of the clamp.

A common form of temporary fencing comprises multiple fencing panels which are releasably clamped together using couplers. Each panel comprises upright end posts between which is supported a panel, e.g. of welded metal mesh. The base of the upright end posts of adjacent panels are supported in a heavy foot block, often manufactured from moulded thermoplastic. The function of the coupler is to hold the panels together. Many couplers are provided with a locking mechanism operable from one side to prevent unauthorised removal of the coupler and dismantling of the fence.

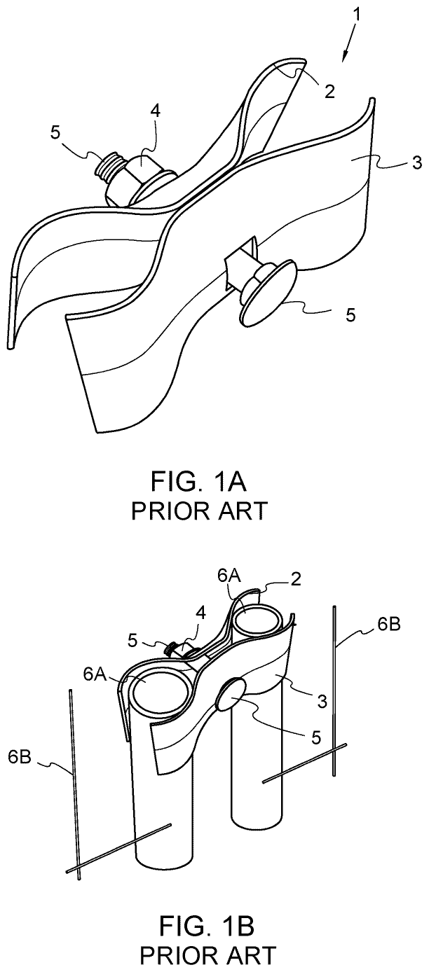

FIGS. 1A and 1B illustrate a prior art clamp 1 of a design commonly used to couple temporary fence panels. The clamp 1 is comprised from two substantially identical clamping parts 2, 3 held together by a nut 4 and bolt 5.

To erect the fence, the moveable fence panels 6, comprising uprights 6A and mesh panel 6B, are placed in a line and adjacent panels coupled together. To couple two adjacent fence panels 6 together, the two clamping parts 2, 3 are manoeuvred onto opposite sides of the fence panels 6 and held in place whilst the nut 4 is turned multiple times over the bolt 5 to tighten the clamping parts 2, 3 against the posts. This is a fiddly and time-consuming process, particularly as the fence posts 6A are often not perfectly parallel. As a consequence, coupling fence panels together often makes up a large proportion of the total time required to erect temporary fencing.

US2004062594 GB2414034 and GB2391560 describe prior art fence couplers. U.S. Pat. No. 4,550,891, GB2064232, US2005260895, U.S. Pat. No. 8,181,928 and CN103075576 describe other prior art couplers.

The present invention was conceived to provide an improved clamp for coupling temporary fencing panels that can be fitted and removed faster and more easily over the prior art.

According to a first aspect of the invention there is provided a clamp, e.g. when used as a fence coupler, the clamp comprising two pairs of clamping jaws, each pair of clamping jaws comprising a fixed jaw and a moveable jaw; the clamp comprising a frame that provide the fixed jaws; each moveable jaw provided by a separate moveable jaw member pivotably mounted to the frame to allow rotation of the moveable jaws relative to their respective fixed jaws to open and close the clamping jaws.

The novel clamp design overcomes the need to arrange two separate clamping parts on opposite sides of the fence thereby simplifying and reducing the time required for attachment and detachment of the clamp to adjacent fence posts.

The clamp typically comprises means to hold the clamping jaws closed. The fixed jaws may be fixed outer jaws and the moveable jaws, moveable inner jaws. This arrangement allows for a simplified means to hold the clamping jaws closed. For example, it may allow for use of a single mechanism to hold the two pairs of jaws shut.

The clamp may comprise a bias means that connects between the moveable jaws members and adapted to bias both moveable jaw members towards their respective fixed jaw members to hold both of the two pairs of clamping jaws in the closed position. This allows the clamp to hold itself in position automatically when pushed onto the uprights.

The clamp can be simply removed from the fencing panels by pulling the clamp laterally away from the fence with a force sufficient to overcome the biasing force of the bias means.

The bias means is considered an inventive concept in its own right and therefore according to a second aspect of the invention there is provided a clamp comprising two pairs of clamping jaws each comprising a first, moveable, jaw member and a second jaw member, and a bias means that connects between the first jaws and is adapted to bias both moveable jaw members towards their respective fixed jaw member to hold the two pairs of clamping jaws in a closed position. The clamp may comprise a frame that provides the second jaws. Each of the moveable jaws may be pivotably mounted to the frame.

According to a third aspect of the invention there is provided a clamp when used as a fence coupler, the clamp comprising two pairs of clamping jaws, and a bias means that bias the two pairs of jaws closed. As before, the clamp may comprise a frame that provides the second jaws. Each of the moveable jaws may be pivotably mounted to the frame.

The following may apply to any of the aspects of the invention mentioned above.

The moveable jaw members may each be pivotably mounted to the frame about a hinge pin or similar mechanism.

The frame may be comprised from a single integral piece. Typically the frame is comprised from metal, though it may be manufactured from other materials such as synthetic polymer.

The bias means may comprise a compression spring, e.g. a helical compression spring. This is a simple and cost-effective method of implementing the bias means.

Each pair of clamping jaws may provide at least one arcuate clamping face for clamping against a convexly curved outer surface of a fence post.

The clamp may include a retaining mechanism selectively operable to inhibit opening of the two pairs of clamping jaws out of a closed position. The retaining mechanism allows for the clamp, once clamped onto fence posts, to be selectively locked onto the fence to inhibit its unauthorised removal.

The retaining mechanism may comprise a restraint member moveable laterally with respect to the frame between a retaining position in which the restraint member is engaged against both movable jaw members when the jaws are closed and a released position in which the restraint member is disengaged and spaced away from the moveable jaw members when the jaws are closed. In practice a user can selectively move the restraint member to the retaining position once the clamping jaws are closed to lock the clamp and to the open position to allow the clamp to be removed from the fence.

Favourably the restraint member is located on an opposite facing side of the frame to that from the pairs of clamping jaws. This inhibits operation of the retaining mechanism from the opposite side of the fence to the clamp. Where the clamp is located on the inner side of the fence perimeter, this prevents the clamp being removed and the fence dismantled by persons outside of the perimeter.

Each moveable jaw member may comprise a projection arranged to protrude into one or more apertures of the frame, and in which the restraint member engages against the projections when the jaws are closed. The projections may protrude through the one or more apertures when the two pairs of clamping jaws are in an open.

There may further be provided a shaft on which the restraint member is mounted for movement along the shaft towards and away from the one or more apertures between the restraining position, which is relatively close to the one or more apertures, that checks the extent that the projections can protrude through the one or more apertures to retain the pair of clamping jaws in a closed position, and the released position, which is relatively far from the one or more apertures to allow the pair of jaws to open to the open position.

The shaft may carry a thread. The thread of the shaft may have a lead length L, and in which the projections are arranged to move not more than a distance equating to lead length L towards or away from the restraint member during opening and closing of the two pairs of clamping jaws.

Each pair of jaws may have a mouth that face the same direction enabling the clamping jaws to be passed, optionally substantially simultaneously, over parallel upright posts of adjacent fence panels when the clamp is moved laterally towards the parallel upright posts. This arrangement allows the clamp to be mounted or removed from two parallel fence posts through a single lateral movement of the clamp towards or away from the fence posts.

A further advantage of this arrangement, is that the coupler is more resistant to being prised off, e.g. by an intruder, through levering fence panels apart in a direction colinear with the fence line. Unlike the prior art clamp, this is because the mouths of the clamp face a direction perpendicular to the line of the fence

This feature is also considered to have independent inventive merit and therefore according to a fourth aspect of the invention there is provided a clamp when used as a fence coupler, the clamp comprising two pairs of clamping jaws, each of the two pairs of jaws having a mouth that face the same direction enabling the clamping jaws to be passed, optionally substantially simultaneously, over parallel upright posts of adjacent fence panels when the clamp is moved laterally towards the parallel upright posts.

According to a further aspect of the invention there is provided a clamp for clamping over circular cross section fence posts; the clamp having two pairs of clamping jaws, each pair comprised of a fixed jaw and a moveable jaw, the fixed jaws provided by a frame, each moveable jaw comprised from a moveable jaw element pivotably mounted to the frame; each pair of clamping jaws providing at least one arcuate clamping face to clamp against a curved outer surface of the post; and the clamp comprising a restraint mechanism to selectively retain the clamping jaws in a closed position, the restraint mechanism including a restraint member that is threadably engaged onto a threaded shaft mounted to the frame, the thread of the shaft having a lead length L; the restraint member arranged to be rotatable about the threaded shaft between a retaining position in which the restraint member is engaged against engagement surfaces of the moveable jaw elements to hold the two pairs of clamping jaws shut, and an open position in which the restraint member is spaced away from the engagement surfaces; and in which the engagement surfaces are arranged to move not more than a distance equating to lead length L towards or away from the restraint member during opening and closing of the two pairs of clamping jaws.

This arrangement allows the clamping jaws to be locked or released with a single turn of the restraint member, significantly increasing the speed at which the clamp can be locked or released.

The invention will now be described by way of example with reference to the following drawings in which:

FIG. 1A is a perspective view of a prior art temporary fence clamp;

FIG. 1B is view of the prior art temporary fence clamp of FIG. 1 coupling two fence panels;

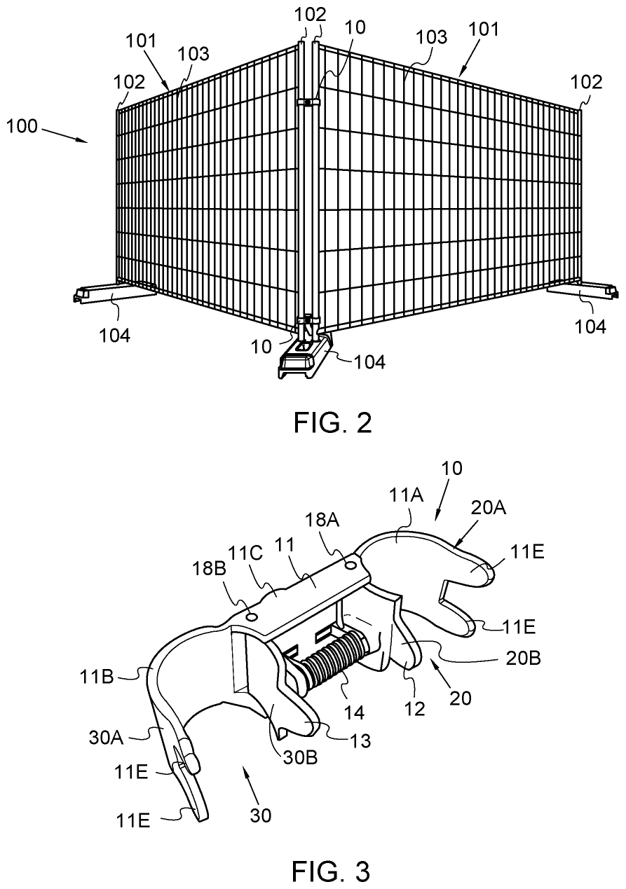

FIG. 2 is a perspective view of two temporary fencing panels of a temporary fence coupled together with a clamp;

FIG. 3 is a first perspective view of the clamp;

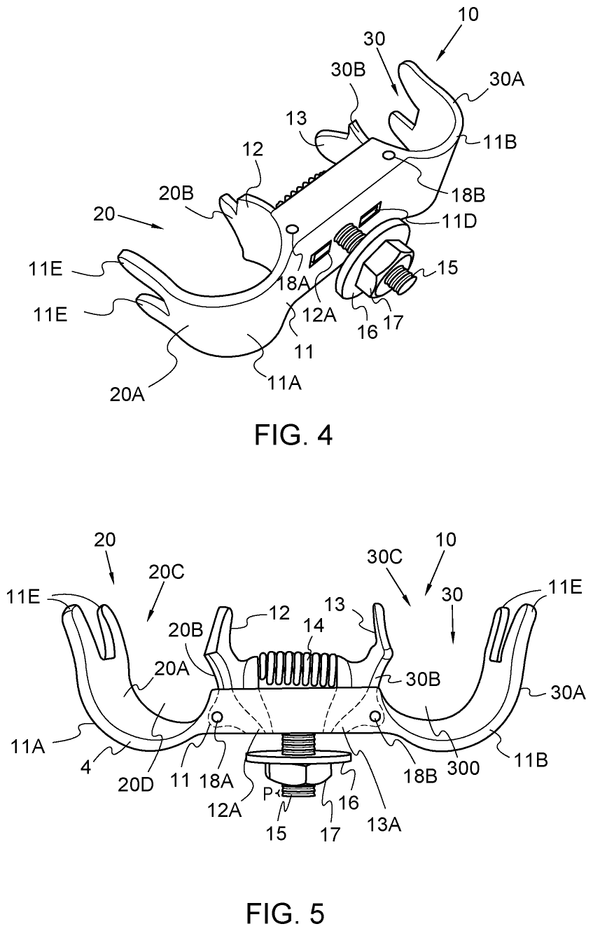

FIG. 4 is a second perspective view of the clamp;

FIG. 5 is a plan view of the clamp;

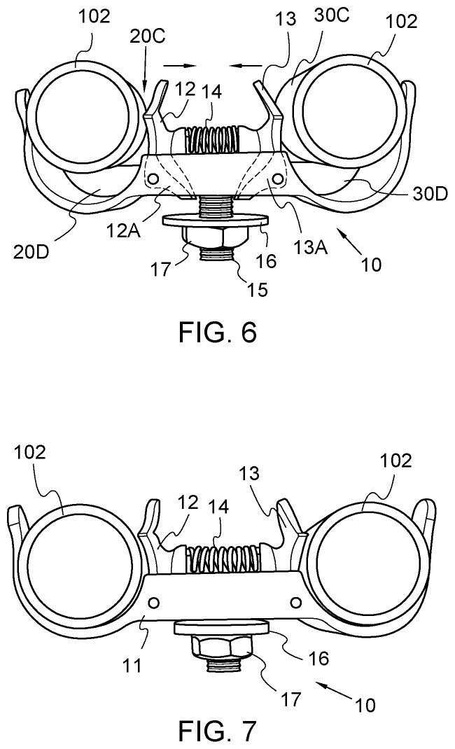

FIG. 6 is a plan view of the clamp being moved against parallel upright posts of adjacent fencing panels;

FIG. 7 is a plan view of the clamp mounted on the upright posts and the retaining mechanism engaged to inhibit removal of the clamp;

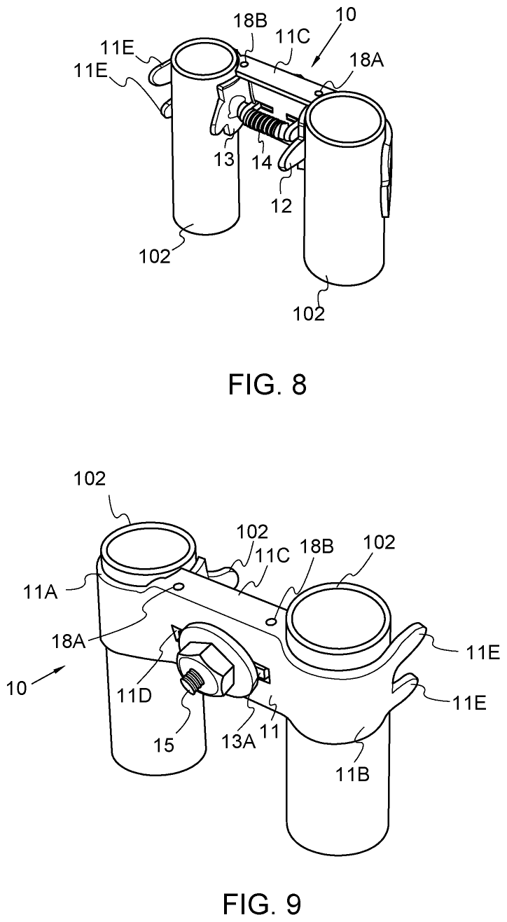

FIG. 8 is a perspective view of the clamp mounted on the upright posts and

FIG. 9 is a second perspective view of the clamp mounted on the upright posts.

With reference FIG. 2, there is illustrated a temporary fence 100 comprising fencing panels 101. Each fencing panel 101 comprises two upright posts 102 between which is supported a metal wire mesh sheet 103. The sheet 103 is typically welded to the posts 102. The fencing panels 101 are held by foot blocks 104. Each foot block 104, which is comprised from moulded thermoplastic, defines a pair of holes that receive the base of adjacent upright posts 102 of adjacent panels 101.

Adjacent panels 101 are coupled together about their adjacent uprights 102 by at least one clamp 10 which is shown in greater detail in FIGS. 3-9. With reference first to FIGS. 3-5, which illustrate the clamp 10 in isolation, the clamp 10 has a first pair of jaws 20 and a second pair of jaws 30 arranged side by side for clamping over parallel upright posts 102 of adjacent fence panels 101.

The clamp 10 comprises a frame piece 11, a first moveable jaw member 12, a second moveable jaw member 13, a helical compression spring 14, a threaded shaft 15, a washer 16 and a nut 17.

The frame member 11 is comprised from a single integral piece of metal, e.g. manufactured by one or more of a moulding, machining, forging and pressing process. The frame member 11 comprises, at a first end, a first arcuate portion 11A providing a first fixed jaw 20A, and at a second end a second arcuate portion 11B providing a second fixed jaw 30A, and between the first and second ends a connecting portion 11C that connects between the first and second arcuate portions 11A 11B. Extending through the connecting portion 11C are apertures 11D.

At the end of each arcuate portion 11A 11B the frame member 11 bifurcates to provide fingers 11E, which extend within the same plane, but in an opposite direction to that of the curve of its respective arcuate portion 11A 11B. In a variant example, this terminal reflexed portion may not be divided into multiple fingers or alternatively may be divided into more than two fingers.

The first moveable jaw member 12 is mounted to the frame member 11 about a first hinge pin 18A at a position adjacent the first arcuate portion 11A to provide a first moveable jaw 20B. The second moveable jaw member 13 is mounted to the frame member 11 about a second hinge pin 18B at a position adjacent the second arcuate portion 11B to provide a second moveable jaw 30B. The pins 18A 18B may be separate components or instead each may be provided by a pair of trunnions integral to and projecting from upper and lower faces (from the perspective shown in FIG. 4) of the respective moveable jaw members.

The first and second moveable jaws members 12 13 are mounted to the frame member 11 so as to lie between the first and second fixed jaw 20A 30A, i.e. the fixed jaws 20A 30A lie outwards of the moveable jaws 12 13.

Together, the first fixed jaw 20A and the first moveable jaw 20B provide the first pair of jaws 20 for clamping to a first upright post 102; and the second fixed jaw 30A with second moveable jaw 30B provide the second pair of jaws 30 for clamping to a second upright post 102.

The first moveable jaw member 12 is rotatable about its hinge pin 18A relative to frame member 11 to permit travel of the first moveable jaw 20B towards and away from the first fixed jaw 20A. Similarly, the second moveable jaw member 13 is rotatable about its hinge pin 18B relative to frame member 11 to permit travel of the second moveable jaw 30B towards and away from the second fixed jaw 30A. The first and second movable jaw members 12 13 rotate about parallel axes of rotation but in opposite directions to one another when the jaws are opened and closed.

The compression spring 14 is connected between the first and second moveable jaw members 12 13. At rest, the compression spring 14 exerts a bias force that holds the moveable jaws 20B 30B apart and towards their respective fixed jaw counterparts 20A 30A such that both pairs of jaws 20, 30 are in a closed state.

In the closed state, the free ends of the fixed and moveable jaws of each pair of jaws 20 30 remain spaced apart to provide openings 20C 30C that face the same direction. By virtue of the reflexed fingers 11E each opening has a tapered form being wider than the dimeter of the uprights 102 at its mouth but narrowing to a spacing that is smaller than the diameter of the upright posts 102.

Each moveable jaw member 12, 13 comprises a nib 12A 13A, indicated by the dashed line in FIGS. 5 and 6 that extends into a different one of the apertures 11D. Each nib 12A 13A is arranged to protrude out through one of the apertures 11D when the moveable jaw members 12 13 are rotated against the bias force of the spring 14 to open the pairs of jaws 20, 30.

The threaded shaft 15 is mounted to the connecting portion 11C between the apertures 11D on an opposite facing side of the frame member 11 to that from which the moveable jaw members 12, 13 extend. The thread of the threaded shaft 15 has as a pitch length P. As in this example the shaft 15 carries a single thread, pitch length P also corresponds to the thread's lead length L. The washer 16 and nut 17 are retained over the shaft 15. The nut 17 is rotatable over the shaft 15 towards and away from the connecting portion 11C between a locked position, in which it is positioned relatively close to the connecting portion 11C, and an open position in which it is spaced relatively far from the connecting portion 11C. The washer 16 has an outer diameter sufficient to extend, at least partially, across both apertures 11D. The degree of freedom of the washer 16 to move laterally away from apertures 11D is governed by the position of the nut 17. In the locked position, the washer 16 is retained by the nut 17 against the connecting portion 11C to prevent the nibs 12A 13B passing out through apertures 12D thus keeping the jaws 20 30 closed.

In the open position the nut 17 is spaced far enough away from the frame member 11 to allow the nibs 12A 13A to protrude through the apertures 11D. The moveable jaw members 12 13 are arranged such that the nibs 12B 13B do not travel by more than a distance equating to the tread's lead length L towards the nut 17 when the jaws are open sufficiently wide to allow the uprights to pass through their respective openings 20C 30C.

This arrangement means that just one revolution of the nut 17 on the shaft 15 is needed to switch between an open state in which the clamp 10 can be attached or removed from the fence, and a locked state in which the clamp 10 is locked onto the fence posts 102.

With reference to FIG. 6, to retain the clamp 10 onto the parallel uprights 102, with the nut 17 in the open position, the clamp 10 is orientated such that the openings 20C 30C of the two pairs of jaws 20 30 face directly towards the respective uprights 102; the clamp 10 is moved laterally towards, i.e. in a direction orthogonal to the primary axis of the uprights 102, to engage the uprights 102 at a point between their upper and lower ends so that the uprights 102 lie in the opening 20C 30C. As the clamp 10 is forced against the uprights 102, each moveable jaw 20B 30B is urged, against the bias force of the compression spring 14, away from its respective fixed jaw 20A 30A widening the openings 20C 30C to allow the upright 102 to pass into a receiving region 20D 30D of the respective jaws 20 30. As the moveable jaws 20B 30B open, the nibs 12A 13B rotate to protrude through the apertures 11D

Once the uprights 102 are within the receiving regions 20D 30D, they no longer act against the bias force of the compression spring 14. Consequently, the moveable jaws 20B 30B move back towards their fix jaw counterparts 20A 30A to clamp against the uprights 102 with sufficient force to retain the clamp 10 in position against the uprights 102.

Once in position, the nut 17 is rotated (one revolution sufficient) on the shaft 15 towards the connecting portion 11C into the locked position as illustrated in FIG. 7 to prevent the pairs of jaws 20 30 from opening.

To remove the clamp 10, the nut 17 is rotated on the shaft 15 (again one revolution sufficient) to the open position, the clamp 10 is then pulled laterally away from the uprights with a force sufficient to overcome the biasing force of the compression spring 14 to urge the moveable jaws 20B 30B together to release the uprights.

Most commercially available fencing of the type described above, such as that provided by Haras (RTM), is of a standardised size. The fence panel uprights may have a diameter of about 38 mm. The feet are often standardised to support the uprights of adjacent panels at a spacing between upright centres of about 90 mm. To provide compatibility with these standards, the pairs of the clamping jaws may have notional centres spaced apart by about 90 mm with a notional diameter of the arcuate clamping face provided by the jaws when the clamps are closed of not more than about 38 mm.

It will be appreciated that the pairs of jaws 20 30 do not need to pass over their respective posts 102 simultaneously. Alternatively, one of the pairs of jaws could be first clamped over one of the uprights 102, then the clamp 10 rotated about that upright to engage the free pair of jaws over the adjacent upright 102.

The afore described clamp is considered to be particularly favoured because it is simple and thus relatively cheap to manufacture. Nevertheless, it will be appreciated that variation to the design is possible. Non-limiting examples of variation are described below.

A coil compression spring is a simple and convenient means of providing a substantially equal ‘push’ biasing force to both moveable jaws simultaneously. Nevertheless, other forms of biasing means are conceivable if not necessarily preferred, e.g. one or more leaf springs or gas springs. Rather than using a single bias means, each moveable jaw could be provided with a separate bias means.

The moveable jaw members may be connected to the frame member 11 by means other than a hinge, in order for example, to provide a linear movement instead of a rotational movement. Nevertheless, this arrangement would not be favourable because it increases design complexity.

Although desirable for cost of manufacture, the frame member 11 may not be a single integral piece.

The openings 20C 30C of the jaws 20 30 may be angled away from parallel whilst still allowing the clamp 10 to be retained onto and removed from fence panels. For example, the openings could face directions angled 90 degrees apart. Where so, it would be necessary to clamp one pair of jaws onto one of the uprights first before rotating the clamp about that upright to bring the other pair of jaws against the other upright. However, this arrangement is less preferred as to enable the clamp to be fitted, the upright post positions would need to move slightly. This is possible at the top of the fence panel but less so towards the bottom where the panel uprights are held by the foot block.

A single, larger, aperture may take the place and provide the function of the separate apertures 11D.

The functions of the washer 16 and nut 17 may be combined through use of a flanged nut or similar.

Favourably the shaft 15 is welded to the connecting portion 11C. Alternatively, the shaft may be provided by a bolt that extends through the connecting portion 11C and is retained in place by a nut lying between the spring 14 and connecting portion 11C. Where so, the head of the bolt may instead provide the function of the nut 17.

The bifurcation of the free end of the frame member 11 is optional. The tapered nature of the openings is also optional.

In a variant, the nibs may be arranged to protrude out slight through the apertures 11D when the moveable jaws 20C 30B are closed, and to move to protrude further through the apertures when the moveable jaw members 12 13 are rotated against the bias force of the spring 14 to open the pairs of jaws 20, 30. This arrangement allows the nut 17 to be tightened, e.g. with a spanner, against the nibs urging the moveable jaws against the uprights so as exert an additional clamping force on the fence uprights over that which the biasing means provides. This may aid to prevent rotation of the clamp 10 relative to the fence panel uprights 102 once locked in position. In this variant, the moveable elements may be arranged such that the nibs do not move towards or away from the nut, when in an open position, by a distance greater than that equating to lead length L.

Diagonal stays are known to be used to provide additional support to a line of fencing where the fence line comprises no sharp changes in direction. Where used, the upper end of a stay can be passed over the threaded bar before the nut and washer are re-fitted and tightened.

1. A clamp comprising two pairs of clamping jaws for clamping uprights of respective fence panels, each pair of clamping jaws comprising a fixed outer jaw and a moveable inner jaw; the clamp comprising a frame that provide the fixed jaws; each moveable inner jaw provided by a separate moveable jaw member pivotably mounted to the frame to allow rotation of the moveable inner jaws relative to their respective fixed outer jaws to open and close the clamping jaws; and the clamp comprises means to hold the pairs of clamping jaws closed.

2. A clamp according to claim 1 comprising a retaining mechanism selectively operable to inhibit opening of the two pairs of clamping jaws out of the closed position.

3. A clamp according to claim 2 in which the retaining mechanism comprises a restraint member moveable laterally with respect to the frame between a retaining position in which the restraint member is engaged against both movable jaw members when the jaws are closed, and a released position in which the restraint member is disengaged and spaced away from the moveable jaw members when the jaws are closed.

4. A clamp according to claim 3 wherein each moveable jaw member comprises a projection arranged to protrude into one or more apertures of the frame and in which the restraint member is engaged against the projections when the jaws are closed.

5. A clamp according to claim 4 wherein the retaining mechanism comprises a threaded shaft on which the restraint member is threadedly mounted; the restraint member moveable along the shaft towards and away from the one or more apertures between the retaining position, which is relatively close to the one or more apertures, to check the extent that the projections can protrude through the one or more apertures in order to retain the pair of clamping jaws in a closed position; and the open position, which is relatively far from the one or more apertures to allow the pair of jaws to open to the open position.

6. A clamp according to any previous claim further comprising a bias means that connects between the moveable jaws members and adapted to bias both moveable jaw members towards their respective fixed jaw members to hold the two pairs of clamping jaws in the closed position.

7. A clamp according to claim 6 wherein the bias means comprises a compression spring.

8. A clamp according to any previous claim wherein the frame member is comprised from a single integral piece defining, at least in part, the fixed jaws.

9. A clamp according to any previous claim when used as a fence coupler.

10. A clamp when used as a fence coupler, the clamp comprising two pairs of clamping jaws, and a bias means that bias the two pairs of jaws closed.

11. A clamp according to claim 10 wherein each of the two pairs of jaws have a mouth that face the same direction to allow the two pairs of clamping jaws to be passed over parallel upright posts of adjacent fence panels when the clamp is moved laterally towards the parallel upright posts.

12. A clamp when used as a fence coupler, the clamp comprising two pairs of clamping jaws, each pair of jaws having a mouth that face the same direction that allow the clamping jaws to be passed over parallel upright posts of adjacent fence panels when the clamp is moved laterally towards the parallel upright posts.

13. A clamp for clamping over circular cross section posts; the clamp having two pairs of clamping jaws, each pair comprised of a fixed jaw and a moveable jaw, the fixed jaws provided by a frame, each moveable jaw comprised from a moveable jaw element pivotably mounted to the frame; each pair of clamping jaws providing at least one arcuate clamping face to clamp against a curved outer surface of the post; and
the clamp comprising a restraint mechanism to selectively retain the clamping jaws in a closed position, the restraint mechanism including a restraint member that is threadably engaged onto a threaded shaft mounted to the frame, the thread of the shaft having a lead length L; the restraint member arranged to be rotatable about the threaded shaft between a retaining position in which the restraint member is engaged against engagement surfaces of the moveable jaw elements to hold the two pairs of clamping jaws shut, and an open position in which the restraint member is spaced away from the engagement surfaces; and
in which the engagement surfaces are arranged to move not more than a distance equating to lead length L towards or away from the restraint member during opening and closing of the two pairs of clamping jaws.

14. A fence comprising multiple moveable fence panels arranged in a line, each fence panel comprising upright members, the upright members of adjacent fence panels retained together by a clamp according to any claim 1-13.

15. A method of assembling a fence comprising, arranging multiple moveable fence panels into a line and coupling adjacent upright posts of adjacent fence panels together using the clamp of any claim 1-13.

16. A kit of parts comprising at least two fence panels and at least one clamp of any claim 1-13.
